(19) United States
(12) Patent Application Publication
(10) Pub. No.: US 2026/0269595 A1
(43) Pub. Date: Sep. 10, 2026

(54) A solid-state circuit breaker module for integration into a power converter

(71) Applicants: Schneider Electric Industries SAS, RUEIL-MALMAISON (FR); DC Systems B.V., Aalsmeer (NL)

(72) Inventors: Lucas SALVETTI, Le Bourg-d'Oisans (FR); Remy ORBAN, Saint-Martin-d'Uriage (FR); Henricus David STOKMAN, Aalsmeer (NL)

(21) Appl. No.: 19/166,403

(22) PCT Filed: Mar. 7, 2024
(86) PCT No.: PCT/EP2024/056034

§ 371 Date: Sep. 17, 2025

(30) Foreign Application Priority Data
Mar. 21, 2023 (EP) 23305382.6

(51) Int. Cl. H02H 3/08

(52) U.S. Cl. CPC H02H 3/08

(57) ABSTRACT

A solid-state circuit breaker module (17) for integration into a power converter, the circuit breaker module (17) having an outer housing (19), the outer housing (19) containing: a. a semiconductor switch (7), which acts as a main overcurrent protection device; b. an electromechanical protective relay (9), which acts as a fallback overcurrent protection device; c. a fuse (35), which acts as an ultimate overcurrent protection device; d. a current sensor for detecting an overcurrent; e. a controller for tripping the semiconductor switch (7) and the protective relay (9) when the current sensor detects an overcurrent; and f. a sealed gas chamber (29) filled with an arc-extinguishing gas, the gas chamber (29) containing the semiconductor switch (7), the protective relay (9), and the fuse (35).

### TECHNICAL FIELD

This disclosure pertains to the field of solid-state circuit breakers. More particularly, it relates to solid-state circuit breakers that are used as devices for protecting electrical power sources in direct current electrical distribution networks against electrical faults such as overloads and short circuits.

### BACKGROUND ART

FIG. 1 shows a typical direct current, or DC, electrical distribution network 100, which might be implemented in an office building or a residential building. Such a DC network 100 has one or more power sources, such as the batteries of electric vehicles 102, the public electrical grid 104, a storage battery 106, or photovoltaic panels 108. The DC network 100 also has a central power distribution bus 110 to distribute the power from the power sources 102, 104, 106, 108 to various loads 112. Each power source 102, 104, 106, 108 is connected to the central bus 110 via a power converter 114. Each power converter 114 converts the current delivered by the corresponding power source to match the voltage rating of the central bus 110.

The power sources 102, 104, 106, 108 must be protected against overcurrent, which typically may be caused by overloads and short circuits in the DC network 100. To this end, a circuit breaker 116 is connected between each power source 102, 104, 106, 108 and the central bus 110, namely to the output of each power converter 114.

It would be advantageous to integrate the circuit breakers 116 with their corresponding power converters 114. This would reduce the number of separate components of the DC network 100, make it more compact and the setup easier.

### SUMMARY

In view of the above, it is an object of the present disclosure to provide a compact circuit breaker, which is well adapted to the overcurrent protection of power sources in DC distribution networks. In particular, the proposed circuit breaker should be easy to integrate into existing power converters.

According to the present disclosure, this object is achieved with a solid-state circuit breaker module for integration into a power converter, the circuit breaker module having an outer housing, the outer housing containing a semiconductor switch, which acts as a main overcurrent protection device, an electromechanical protective relay, which acts as a fallback overcurrent protection device, a fuse, which acts as an ultimate overcurrent protection device, a current sensor for detecting an overcurrent, a controller for tripping the semiconductor switch and the protective relay when the current sensor detects an overcurrent, and a sealed gas chamber filled with an arc-extinguishing gas, the gas chamber containing the semiconductor switch, the protective relay, and the fuse.

Indeed, by arranging the main, fallback and ultimate overcurrent protection device, viz., the semiconductor switch, the protective relay and the fuse, in a single sealed gas chamber, one obtains a compact circuit breaker module, which can be directly mounted into a power converter. In this way, the circuit breaker becomes an integral part of the power converter. By using the circuit breaker module of the present disclosure, one can thus replace each component pair 114, 116 in FIG. 1 by a single power converter with a protected output.

The following features can be optionally implemented, separately or in combination with each other:
the controller is located outside of the sealed gas chamber;
an input/output connector on the outer housing for communication between the controller and an external device connected to the circuit breaker module via the input/output connector;
an inductor to delay the current rise in case of an overcurrent, the inductor being arranged inside the gas chamber;
the fuse is a bond wire interconnecting the semiconductor switch and the protective relay, the bond wire being designed to melt in the presence of a sustained overcurrent;
a rotatable key socket on the outer housing, which can be rotated by inserting therein and turning a hand key to reset the protective relay when it has tripped;
the protective relay comprises two spaced-apart fixed contacts, a displaceable contact, which can be displaced between a closed state, in which it touches both fixed contacts and thus establishes an electrical connection between the two fixed contacts, and an open state, in which it is separate from the two fixed contacts, such that the two fixed contacts are electrically isolated, and a displacement device for displacing the displaceable contact from its closed state to its open state, wherein the displacement device includes a rotatable bar, a rotation of which displaces the displaceable contact, a spiral spring urging the rotatable bar to rotate into a position, which corresponds to the open state of the displaceable contact, an electromagnetic coil, which, when energized, maintains the rotatable bar in a position, which corresponds to the closed state of the displaceable contact, against the urge of the spiral spring, and wherein the controller trips the protective relay by de-energizing the electromagnetic coil;
the rotatable bar comprises a ferromagnetic material and is located close to a wall of the gas chamber, the circuit breaker module further comprises a rotatable permanent magnet, which is located close to the rotatable bar, on the opposite side of the gas chamber wall, and, when resetting the protective relay by turning the key socket, the permanent magnet follows the rotation of the key socket and thereby magnetically induces, across the gas chamber wall, a rotation of the rotatable bar displacing the displaceable contact into its closed state, against the urge of the spiral spring;
the gas chamber is delimited by a rigid enclosure and an elastic sealing bellows set into the rigid enclosure, the bellows being in mechanical contact with the protective relay to allow resetting of the protective relay from outside of the gas chamber by mechanical action on the bellows.

### BRIEF DESCRIPTION OF THE DRAWINGS

These and other features, details and advantages will be shown in the following detailed description and on the figures, in which:

FIG. 1 shows a known DC electrical distribution network in which circuit breaker modules of the present disclosure may be implemented.

FIG. 2 is a diagram of an electrical circuit that may be implemented in a circuit breaker module according to the present disclosure.

FIG. 3 is a top view of a circuit breaker module according to the present disclosure.

FIG. 4 is a sectional side view of the circuit breaker module of FIG. 3.

FIG. 5 is another sectional side view of the circuit breaker module of FIG. 3 showing the arrangement inside the gas chamber.

FIG. 6 is a schematic drawing showing the components of the displacement device of the protective relay of the circuit breaker module of FIGS. 3 to 5.

FIG. 7 is an illustration of a bond wire fuse that may be used in the circuit breaker module of FIG. 3 to 5.

FIG. 8 and FIG. 9 show a different embodiment of the present disclosure, which has an elastic sealing bellows allowing resetting of the protective relay from outside of the gas chamber.

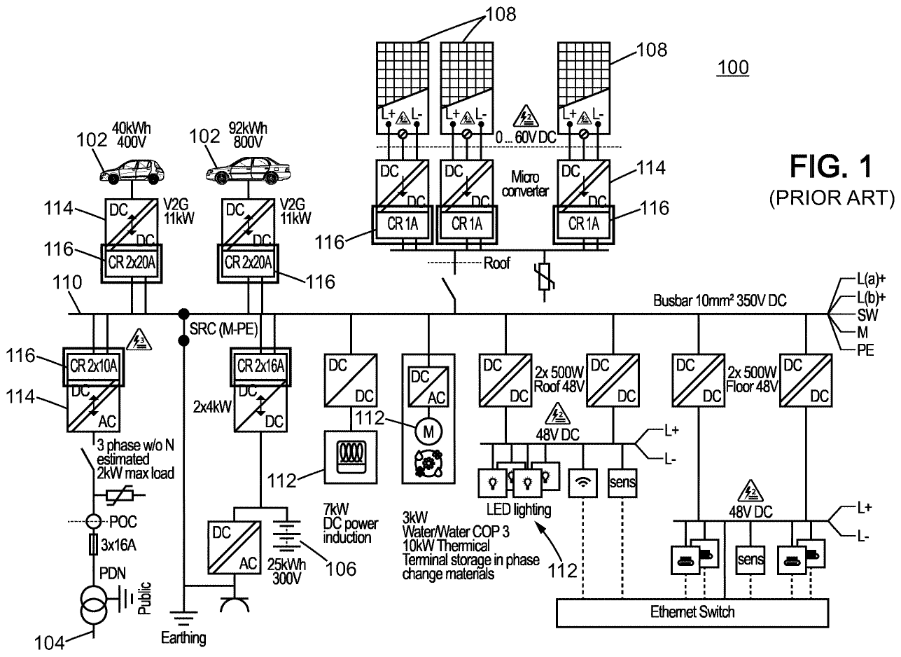

### DESCRIPTION OF EMBODIMENTS

The solid-state circuit breaker modules that will now be described in detail are self-contained electrical units, which are meant to be integrated into larger electrical devices. In one preferred application, these solid-state circuit breaker modules can be integrated into power converters. More precisely, the output of a power converter may be protected against overcurrents by fitting a solid-state circuit breaker module of the present disclosure between the DC-link capacitor and the output terminals of the power converter. A solid-state circuit breaker module of the present disclosure may for example be mounted on the printed circuit board of the power converter that is to be protected.

Solid-state circuit breaker modules as described herein, when used as protection devices in electrical distribution networks, will each be mounted next to the source that they protect. This distributed/decentralised protection architecture is advantageous in that it dispenses with the traditional central distribution cabinets housing many individual circuit breakers.

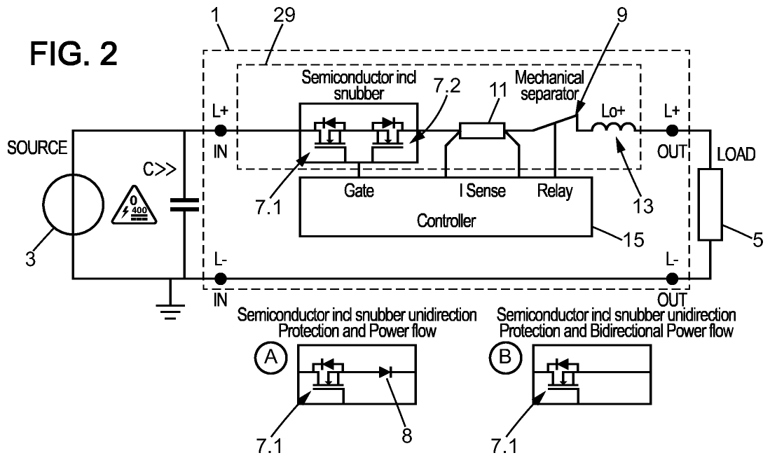

A solid-state circuit breaker module of the present disclosure typically has an electrical circuit like the one shown in FIG. 2. This electrical circuit 1 (delimited by a dashed rectangle) is a DC circuit with two inputs L+IN and L−IN, and two outputs L+OUT and L−OUT. It is a protection circuit, which protects a source 3 connected to its inputs L+IN and L−IN from overcurrents. The protection circuit 1 may provide bidirectional protection, i.e., may not only protect the source 3 from overcurrents, but also a load 5 connected to its outputs L+OUT and L−OUT. This will be explained in more detail further below.

The protection circuit 1 includes a main overcurrent protection device, namely one or more semiconductor switches 7, a fallback overcurrent protection device, namely an electromechanical protective relay 9, a current sensor 11 for detecting an overcurrent, a current rise delaying/time-buyer inductor 13, and a controller 15 connected to the semiconductor switches 7, the current sensor 11 and the protective relay 9.

In the protection circuit 1 shown in FIG. 2, the main overcurrent protection device comprises two semiconductor switches 7.1 and 7.2. Each semiconductor switch 7.1 and 7.2 is implemented as a transistor, here an N-channel MOSFET in depletion mode. Other transistors or other semiconductor devices may alternatively be used. The first semiconductor switch 7.1 protects the source 3 from an overcurrent, and the second semiconductor switch 7.2 protects the load 5 from an overcurrent. Indeed, as apparent from FIG. 2, the two transistors 7.1, 7.2 are connected in anti-series. The controller 15 can act on the gates of the transistors 7.1 and 7.2 to trip one, or the other, or both in the case of an overcurrent.

As illustrated by the small diagrams A and B at the bottom of FIG. 2, the main overcurrent protection device may also have a single semiconductor switch 7.1 instead of two semiconductor switches. The single semiconductor switch 7.1, which, again, may preferably be a transistor, will then only protect the source 3 from an overcurrent but not the load 5. As apparent from diagram A, a diode 8 may be added in series with the single transistor 7.1 to ensure that power may only flow in one direction, from the source 3 to the load 5.

Turning back to the protection circuit 1, the current sensor 11 is connected in series with the semiconductor switches 7.1 and 7.2. The current sensor 11 may be implemented as a resistor. The controller 15 monitors the voltage across the resistor 11, and thus the current flow.

The protective relay 9 is connected downstream of and in series with the transistors 7.1 and 7.2 and the current sensing resistor 11. The controller 15 trips the protective relay 9 when the current sensor 11 detects an overcurrent, concurrently with the first and/or second transistors 7.1, 7.2.

The time-buyer inductor 13 is connected in series between the protective relay 9 and the output L+OUT. The time-buyer inductor 13 delays the current rise in case of an overcurrent so that the current interrupting components, i.e., the semiconductor switches 7.1, 7.2 and, if applicable, the protective relay 9, have sufficient time to react and break the circuit.

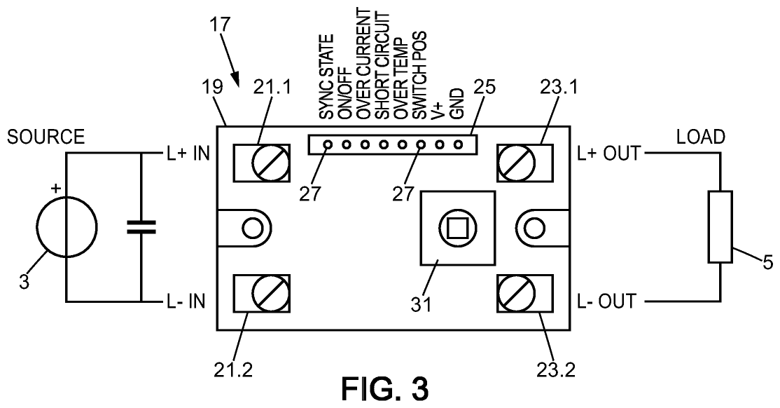

With reference to FIGS. 3 to 5, we will now describe the physical layout of an exemplary solid-state circuit breaker module according to the present disclosure.

The solid-state circuit breaker module 17 shown in FIGS. 3 to 5 is a self-contained device, which may be bought individually. It may be mounted on a printed circuit board together with other modules or electronic components.

The solid-state circuit breaker module 17 contains the protection circuit 1 of FIG. 2.

The circuit breaker module 17 is delimited by an outer housing 19. A pair of input terminals 21.1 and 21.2 is arranged at one end of the outer housing 19. A pair of output terminals 23.1, 23.2 is arranged at the other end of the outer housing 19. A source 3 may be connected to the input terminals 21 and a load 5 to the output terminals 23 (cf. FIG. 3). Under normal operating conditions, power flows from the source 3 via the circuit breaker module 17 to the load 5. However, in case of an overcurrent, the circuit breaker module 17 will interrupt the current flow from the source 3 to the load 5. In other words, the circuit breaker module 17 is arranged between the source 3 and the load 5 and may disconnect the load 5 from the source 3, e.g., in case of a short circuit or if the load 5 is overloading the source 3.

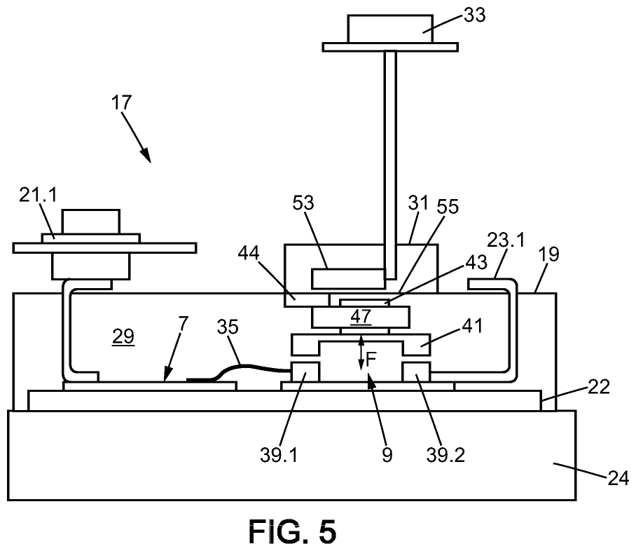

The circuit breaker module 17 may comprise a cooling plate 22, which may be arranged at the bottom of the outer housing 19. The cooling plate 22 may be implemented as a metal substrate. The function of the cooling plate 22 is to absorb the heat generated by the protection circuit 1 during operation of the circuit breaker module 17. When the circuit breaker module 17 is integrated into a larger device, such as a power converter, its cooling plate 22 may be brought into contact with a heat sink 24 of the larger device, cf. FIG. 5. In such a configuration, the heat generated by the circuit breaker module 17 is dissipated by the larger device's heat sink 24. One may thus design the circuit breaker module 17 without any heat sink.

The circuit breaker module 17 may also have an input-output connector 25 located on the outer housing 19. The input-output connector 25 includes a set of connecting pins 27. The input-output connector 25 is an interface to allow communication between the circuit breaker module's controller 15 and an external device, such as the microcontroller of the power converter into which the circuit breaker module 17 is integrated. An external device may thus be connected to the circuit breaker module 17 via the input-output connector 25. The pins 27 of the input-output connector 25 may be used for example to supply power to the circuit breaker module 17, to synchronise the voltage with that of the electrical grid to which the circuit breaker module 17 is connected, to indicate errors to the external device (overload, overcurrent, overvoltage, overtemperature), or to switch the circuit breaker module 17 on or off.

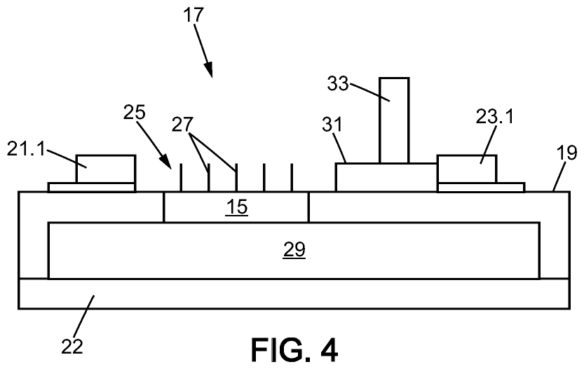

With reference to FIG. 4, a sealed gas chamber 29, filled with an arc-extinguishing gas, is located inside the outer housing 19. The sealed gas chamber 29 is identified in FIG. 2 by a dashed rectangle. The arc-extinguishing gas in the gas chamber 29 may be an inert gas, such as sulphur hexafluoride (SF6).

According to the present disclosure, the gas chamber 29 contains the main components of the circuit breaker module 17 that are relevant to interrupting the current, in particular the one or more semiconductor switches 7 and the protective relay 9. Preferably, the time-buyer inductor 13 is also arranged inside the single gas chamber 29. By concentrating the main current-interrupting components in a single gas chamber, the circuit breaker module 17 becomes very compact. The resulting small size of the circuit breaker module 17 allows it to be easily integrated e.g., into a power converter. As apparent from FIGS. 2 and 4, the controller 15 is located inside the outer housing 19 but outside of the sealed gas chamber 29. The controller 15 may sit on top of the sealed gas chamber 29.

Preferably, a rotatable key socket 31 is arranged on the outer housing 19. A hand key 33 (cf. FIGS. 4 and 5) can be inserted into the rotatable socket 31. Turning the inserted hand key 33 results in rotation of the socket 31, which in turn resets the protective relay 9, when it has tripped.

In the illustrated embodiment, see FIG. 5, the sealed gas chamber 29 also contains a fuse 35, which acts as an ultimate overcurrent protection device. The fuse 35 will blow if, in case of an overcurrent, both the one or more semiconductor switches 7 and the protective relay 9 failed to break the circuit.

Preferably, the fuse 35 is implemented as a bond wire interconnecting the one or more semiconductor switches 7 and the protective relay 9. The bond wire 35 is designed to melt in the presence of a sustained overcurrent. An exemplary bond wire fuse 35 is shown in FIG. 7. This particular bond wire 35 has a segment 37 with a reduced cross-section. If an overcurrent I flows through the bond wire fuse 35, the thinner segment 37 will heat excessively and melt. Consequently, the bond wire 35 will be cut in two and the current will cease flowing therethrough.

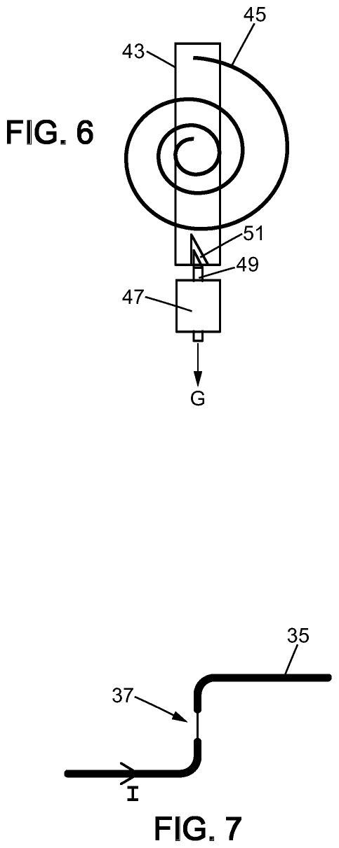

We will now describe the setup of the protective relay 9, with reference to FIGS. 5 and 6.

As apparent from FIG. 5, the protective relay 9 comprises two spaced-apart fixed contacts 39.1 and 39.2, a displaceable contact 41, and a displacement device for displacing the displaceable contact 41. Although the present embodiment discloses two fixed contacts 39.1 and 39.2, it should be understood that the protective relay can comprise more than two fixed contacts, such as 2×n contacts with n being an integer greater than 1. Having more contacts allows to reduce the stroke of the displacement device with respect to the required dielectric insulation when the protective relay 9 is tripped.

As illustrated by the double-arrow F in FIG. 5, the displaceable contact 41 can be moved up and down. More precisely, the displaceable contact 41 can be displaced between a closed state, in which it touches both fixed contacts 39.1 and 39.2 and thus establishes an electrical connection between the two fixed contacts, and an open state, shown in FIG. 5, in which it is separate from the two fixed contacts 39.1 and 39.2, such that the two fixed contacts are electrically isolated. Under normal operating conditions, the displaceable contact 41 is in the closed state to allow current flow through the circuit breaker module 17. In case of an overcurrent, the controller 15 trips the protective relay 9 so that the displaceable contact 41 moves from the closed state to the open state. When the displaceable contact 41 is in the open state, no current can flow through the circuit breaker module 17. Any electrical arcs created when the displaceable contact 41 moves away from the fixed contacts 39.1 and 39.2 are extinguished by the inert gas in the sealed gas chamber 29.

The displacement device of the protective relay 9 includes a rotatable bar 43, a spiral spring 45, an electromagnetic coil 47, and a locking bolt 49. The rotatable bar 43 is mechanically connected to the displaceable contact 41 so that a rotation of the rotatable bar 43 moves the displaceable contact 41 between its open state and its closed state. The spiral spring 45 urges the rotatable bar 43 to rotate into a position, which corresponds to the open state of the displaceable contact 41. Accordingly, the rotatable bar 43 can rotate between a wound-up position, which corresponds to the closed state of the displaceable contact 41, and an unwound position, which corresponds to the open state of the displaceable contact 41.

The function of the locking bolt 49 is to maintain the rotatable bar 43 in the wound-up position, and thus the protective relay 9 in the closed position. To maintain the rotatable bar 43 in the wound-up position, the locking bolt 49 is inserted into a complementary groove 51 of the rotatable bar 43.

The protective relay 9 can be tripped by removing the locking bolt 49 from the groove 51 in the rotatable bar 43. Indeed, when the locking bolt 49 is removed from the groove 51, the rotatable bar 43 will rotate into the unwound position under the urge of the spiral spring 45, which in turn will bring the displaceable contact 41 into the open state.

The insertion of the locking bolt 49 into the groove 51 and the removal therefrom is controlled by the electromagnetic coil 47. As apparent from FIG. 6, the electromagnetic coil 47 surrounds the locking bolt 49. The locking bolt 49 behaves like a plunger inside the electromagnetic coil 47. When the electromagnetic coil 47 is energised, it pushes the locking bolt 49 into the corresponding groove 51. When the electromagnetic coil 47 is de-energised by the controller 15, the locking bolt 49 drops back into the coil 47, as indicated by arrow G in FIG. 6. Hence, when energised, the coil 47 maintains the rotatable bar 43 in a position, which corresponds to the closed state of the displaceable contact 41, against the urge of the spiral spring 45. In short, the controller 15 trips the protective relay 9 by de-energising the electromagnetic coil 47.

The rotatable bar 43 of the just-described displacement device cooperates with a rotatable permanent magnet 53, such as a bar magnet, which is fitted to the rotatable key socket 31, cf. FIG. 5. The permanent magnet 53 rotates in unison with the key socket 31. Hence, a twisting of the hand key 33 results in a corresponding rotation of the key socket 31 and the permanent magnet 53.

As apparent from FIG. 5, the permanent magnet 53 is located close to the rotatable bar 43 of the protective relay 9. In fact, the permanent magnet 53 and the rotatable bar 43 are located on opposite sides of an upper wall 55 of the gas chamber 29. More precisely, the permanent magnet 53 is arranged in proximity to the gas chamber wall 55, outside of the gas chamber 29, and the rotatable bar 43 is also arranged in proximity to the gas chamber wall 55, but inside the gas chamber 29. In other words, the permanent magnet 53 and the rotatable bar 43 face each other while being separated by the gas chamber wall 55.

The rotatable bar 43 comprises a ferromagnetic material. Accordingly, the rotatable bar 43 is susceptible to a magnetic force exerted by the permanent magnet 53 across the gas chamber wall 55.

With reference to FIG. 5, a contact sensor 44 is arranged inside the gas chamber 29, above the protective relay 9. The contact sensor 44 is adapted to detect the current state of the protective relay 9, i.e., whether the relay 9 is in the operational or tripped state. The contact sensor 44 may for example be a device that monitors the electric current drawn by the electromagnetic coil 47.

We will now explain how the protective relay 9, once it has tripped, can be reset with the help of the hand key 33 and the rotatable key socket 31.

Resetting the protective relay 9 is done in the following way: a user inserts the hand key 33 into the key socket 31 and turns the hand key 33. This results in a rotation of the key socket 31, which is followed by the permanent magnet 53. The rotation of the permanent magnet 53 magnetically induces, across the gas chamber wall 55, a rotation of the rotatable bar 43. The rotation of the rotatable bar 43 then moves the displaceable contact 41 into its closed state, against the urge of the spiral spring 45. This re-establishes an electrical connection between the two fixed contacts 39.1 and 39.2, and thus the protective relay 9 is reset.

It will be noted that the just-described arrangement with an external permanent magnet 53 acting on a magnetic bar 43 inside the gas chamber 29 is particularly advantageous since it allows resetting the protective relay 9 from outside of the gas chamber 29 without compromising the tightness of the gas chamber 29. Thanks to this arrangement, the protective relay 9 can be located inside the sealed gas chamber 29 and still be controlled from the outside.

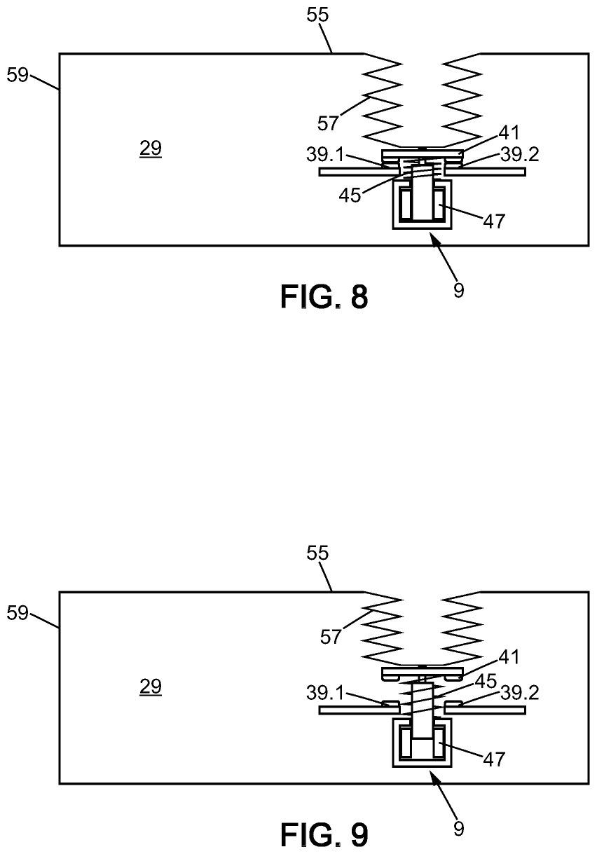

Turning now to FIGS. 8 and 9, these two figures show a second embodiment, which also has a protective relay 9 inside a sealed gas chamber 29 and a mechanism to reset the protective relay 9 from outside of the gas chamber 29, this mechanism maintaining the tightness of the gas chamber 29. In this second embodiment, the permanent magnet 53 and the magnetic bar 43 are replaced by an elastic sealing bellows 57. Here, the gas chamber 29 is the delimited by a rigid enclosure 59 and the elastic sealing bellows 57, set into the rigid enclosure 59. The bellows 57 is in mechanical contact with the protective relay 9 to allow resetting of the protective relay 9 from outside of the gas chamber 29 by mechanical action on the bellows 57.

FIG. 8 shows the bellows 57 and the protective relay 9 in the normal operating state, where the protective relay 9 is closed. According to an embodiment, a mechanical latch (not illustrated) can be used instead of an electromagnetic coil 47 to retain the displaceable contact 41 in a closed state with the fixed contacts 39, thus allowing reducing electromagnetic power consumption.

FIG. 9 shows the bellows 57 and the protective relay 9 in a tripped state, where the protective relay 9 is open. To move from the normal operating state to the tripped state, the spiral spring 45 urges the displaceable contact 41 away from the fixed contacts 39. The stiffness of the spiral spring 45 can be designed to find a trade-off between a sufficient opening speed to move from the normal operating state to the tripped state, and a reduced power consumption of electromagnetic coil 47.

Since the spiral spring 45 exerts a force on the displaceable contact 41 that is greater than the one exerted by the bellows 57, a gap remains between the displaceable contact 41 and the fixed contacts 39 in the tripped state.

To reset the displaceable contact 41 back into the normal operating state, a mechanical action can be applied on the displaceable contact 41 from outside of the sealed gas chamber 29. The displaceable contact 41 remains in the normal operating state as the bellows 57 and the electromagnetic coil 47 (or mechanical latch) exert a cumulative force that is greater than the one from the spiral spring 45 on the displaceable contact 41.

Thanks to the elastic sealing bellows 57, one can reconcile the two conflicting aims of keeping the gas chamber 29 tight and being able to control the protective relay 9 from outside.

Besides, in an embodiment, the module 17 can include a mechanical position indicator to know the state of the protective relay 9. This indicator may be the bellows 57, which may be directly visible through the enclosure 59. This arrangement thus allows to directly and mechanically reflect the state of the displaceable contact 41 by the position of the bottom of the bellows 57.

1. A solid-state circuit breaker module for integration into a power converter the circuit breaker module having an outer housing the outer housing containing:
a. a semiconductor switch, which acts as a main overcurrent protection device;
b. an electromechanical protective relay, which acts as a fallback overcurrent protection device;
c. a fuse, which acts as an ultimate overcurrent protection device;
d. a current sensor for detecting an overcurrent;
e. a controller for tripping the semiconductor switch and the protective relay when the current sensor detects an overcurrent; and
f. a sealed gas chamber filled with an arc-extinguishing gas, the gas chamber containing the semiconductor switch the protective relay and the fuse.

2. The circuit breaker module of claim 1, wherein the controller is located outside of the sealed gas chamber.

3. The circuit breaker module of claim 1, further comprising an input/output connector on the outer housing for communication between the controller and an external device connected to the circuit breaker module via the input/output connector

4. The circuit breaker module of claim 1, further comprising an inductor to delay the current rise in case of an overcurrent, the inductor being arranged inside the gas chamber

5. The circuit breaker module of claim 1, wherein the fuse is a bond wire interconnecting the semiconductor switch and the protective relay the bond wire being designed to melt in the presence of a sustained overcurrent.

6. The circuit breaker module claim 1, further comprising a rotatable key socket on the outer housing which can be rotated by inserting therein and turning a hand key to reset the protective relay when it has tripped.

7. The circuit breaker module of claim 1, wherein the protective relay comprises:
a. two spaced-apart fixed contacts;
b. a displaceable contact which can be displaced between:
i. a closed state, in which it touches both fixed contacts and thus establishes an electrical connection between the two fixed contacts, and
ii. an open state, in which it is separate from the two fixed contacts, such that the two fixed contacts are electrically isolated; and
c. a displacement device for displacing the displaceable contact from its closed state to its open state, wherein the displacement device includes:
i. a rotatable bar, a rotation of which displaces the displaceable contact;
ii. a spiral spring urging the rotatable bar to rotate into a position, which corresponds to the open state of the displaceable contact;
iii. an electromagnetic coil which, when energized, maintains the rotatable bar in a position, which corresponds to the closed state of the displaceable contact against the urge of the spiral spring,
and wherein the controller trips the protective relay by de-energizing the electromagnetic coil.

8. The circuit breaker module of claim 7, wherein:
a. the rotatable bar comprises a ferromagnetic material and is located close to a wall of the gas chamber;
b. the circuit breaker module further comprises a rotatable permanent magnet which is located close to the rotatable bar on the opposite side of the gas chamber wall; and
c. when resetting the protective relay by turning the key socket, the permanent magnet follows the rotation of the key socket and thereby magnetically induces, across the gas chamber wall, a rotation of the rotatable bar displacing the displaceable contact into its closed state, against the urge of the spiral spring.

9. The circuit breaker module of claim 1, wherein the gas chamber is delimited by a rigid enclosure and an elastic sealing bellows set into the rigid enclosure, the bellows being in mechanical contact with the protective relay to allow resetting of the protective relay from outside of the gas chamber by mechanical action on the bellows.

10. The circuit breaker module claim 6, wherein the protective relay comprises:
a. two spaced-apart fixed contacts;
b. a displaceable contact, which can be displaced between:
i. a closed state, in which it touches both fixed contacts and thus establishes an electrical connection between the two fixed contacts, and
ii. an open state, in which it is separate from the two fixed contacts, such that the two fixed contacts are electrically isolated; and
c. a displacement device for displacing the displaceable contact from its closed state to its open state, wherein the displacement device includes:
i. a rotatable bar, a rotation of which displaces the displaceable contact;
ii. a spiral spring urging the rotatable bar to rotate into a position, which corresponds to the open state of the displaceable contact;
iii. an electromagnetic coil, which, when energized, maintains the rotatable bar in a position, which corresponds to the closed state of the displaceable contact, against the urge of the spiral spring,
and wherein the controller trips the protective relay by de-energizing the electromagnetic coil.

11. The circuit breaker module of claim 10, wherein:
a. the rotatable bar comprises a ferromagnetic material and is located close to a wall of the gas chamber;
b. the circuit breaker module further comprises a rotatable permanent magnet, which is located close to the rotatable bar, on the opposite side of the gas chamber wall; and
c. when resetting the protective relay by turning the key socket, the permanent magnet follows the rotation of the key socket and thereby magnetically induces, across the gas chamber wall, a rotation of the rotatable bar displacing the displaceable contact into its closed state, against the urge of the spiral spring.

12. A method of protecting a power source in a direct current electrical distribution network, the method comprising:
providing a solid-state circuit breaker module having a semiconductor switch, an electromechanical protective relay, and a fuse contained within a sealed gas chamber filled with an arc-extinguishing gas;
detecting an overcurrent condition using a current sensor;
tripping the semiconductor switch in response to detecting the overcurrent condition; and
tripping the electromechanical protective relay as a fallback protection in response to detecting the overcurrent condition.

13. The method of claim 12, wherein tripping the semiconductor switch comprises de-energizing the semiconductor switch.

14. The method of claim 12, wherein tripping the electromechanical protective relay comprises de-energizing an electromagnetic coil that maintains a displaceable contact of the protective relay in a closed state against an urge of a spiral spring.

15. The method of claim 14, further comprising rotating a key socket on an outer housing of the circuit breaker module to reset the protective relay after tripping, wherein rotating the key socket causes a permanent magnet to magnetically induce rotation of a rotatable bar across a wall of the gas chamber, thereby displacing the displaceable contact back into the closed state.

16. The method of claim 12, further comprising activating the fuse when both the semiconductor switch and the electromechanical protective relay fail to interrupt the overcurrent condition, wherein the fuse comprises a bond wire designed to melt in the presence of a sustained overcurrent.
